(19) United States
(12) Patent Application Publication
(10) Pub. No.: US 2012/0104191 A1
(43) Pub. Date: May 3, 2012

(54) STAND ASSEMBLY

(75) Inventor: ZHEN-XING YE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 12/954,659

(22) Filed: Nov. 25, 2010

(30) Foreign Application Priority Data
Oct. 29, 2010 (CN) 201010524997.2

(51) Int. Cl. F16M 11/04

(52) U.S. Cl. 248/125.1

(57) ABSTRACT

A stand assembly includes a base comprising a seat and a pivot pole rotatably mounted to the seat, and a support used to support a notebook computer. The support is mounted to the pivot pole, with a height of the support on the pivot pole being adjustable.

### BACKGROUND

1. Technical Field

The present disclosure relates to a stand assembly for portable devices.

2. Description of Related Art

Due to small size and light weight, notebook computers are easy to carry and use in a variety of occasions. However, people find it inconvenient to use the notebook computer where there no appropriate support to set the computer on, such as at certain outdoor locations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an exemplary embodiment of a stand assembly in use, the stand assembly includes a base and a support.

FIG. 2 is an enlarged view of the base of FIG. 1.

FIG. 3 is a sectional view of the base taken along the line III-III of FIG. 2.

FIG. 4 is an enlarged view of the support of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

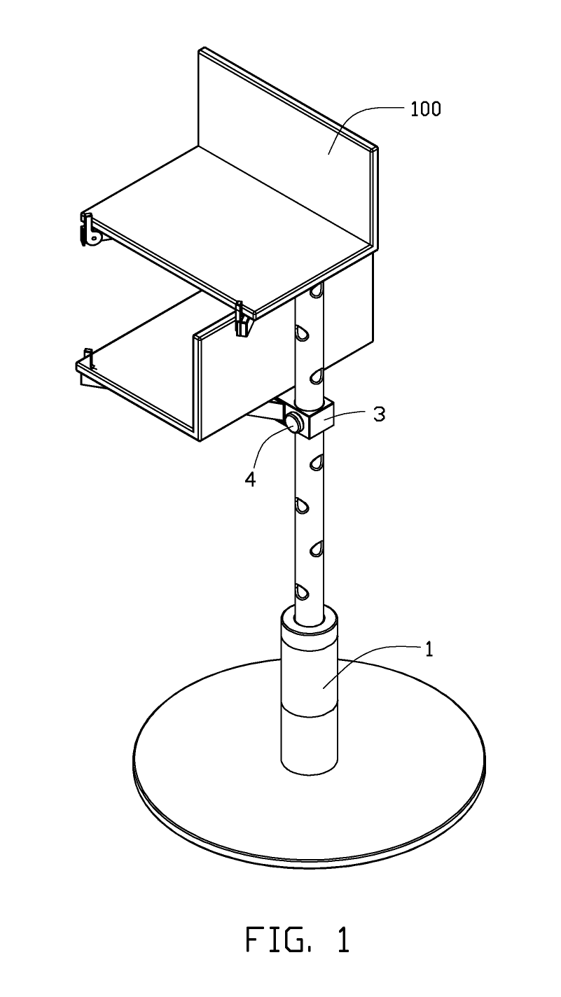

Referring to FIG. 1, an exemplary embodiment of a stand assembly used to support two notebook computers 100, includes a base 1, two supports 3 for supporting the notebook computers 100 respectively, and two fasteners 4 to fasten the supports 3 to the base 1 at different heights. In other embodiments, the stand assembly can be used to support a single notebook computer 100 using either of the supports 3.

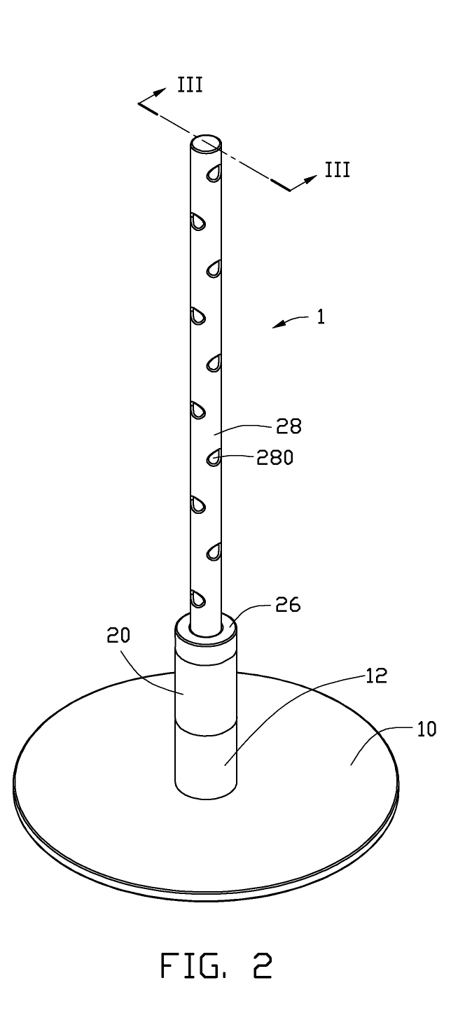

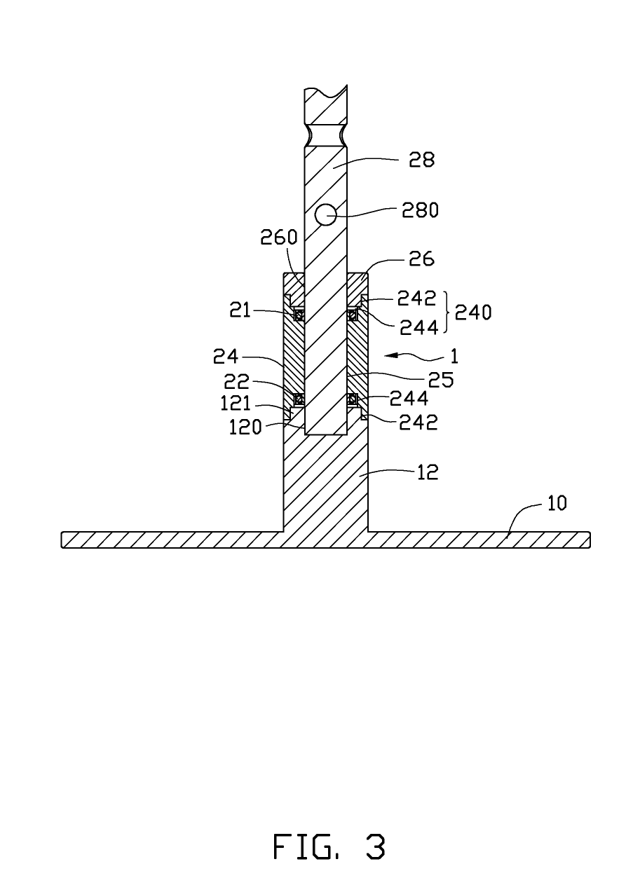

Referring to FIGS. 2 and 3, the base 1 includes a discoid seat 10 and a rotatable portion 20 rotatably mounted to the seat 10. A post 12 protrudes up from a center of the seat 10. A top of the post 12 opposite to the seat 10 is narrowed to form a shoulder 121. The post 12 defines a receiving space 120 in the top of the post 12, along an axis of the post 12. The rotatable portion 20 includes two bearings 21 and 22, a sleeve 24, a cover 26, and a pivot pole 28. The bearings 21 and 22 are both deep groove ball bearings. The sleeve 24 axially defines a through hole 25. Each of opposite ends of the sleeve 24 axially defines a substantially T-shaped receiving portion 240 communicating with the through hole 25. Each receiving portion 240 includes a great first groove 242 through a corresponding distal end of the sleeve 24, and a lesser second groove 244 communicating the through hole 25 with the first groove 242. The first groove 242 has a larger radius than the second groove 244, and the second groove 244 has a larger radius than the through hole 25. The cover 26 is substantially T-shaped, and axially defines a through hole 260. The pivot pole 28 is hollow, and defines a plurality of mounting holes 280 therein at different heights.

The bearings 21 and 22 are respectively received in the second grooves 244 of the receiving portions 240 at the opposite ends of the sleeve 24, with outer surfaces of the bearings 21 and 22 engaging with inner surfaces of the sleeve 24. The cover 26 is mounted to one end of the sleeve 24 opposite to the seat 10, with an end of the cover 26 received in the first groove 242 of the corresponding receiving portion 240, and an outer surface of the cover 26 engaging with the inner surface of the sleeve 24. In other embodiments, the cover 26 can be mounted to the sleeve 24 by threaded fitting. The first groove 242 at the other end of the sleeve 24 fixedly fits about the shoulder 121 of the post 12. The pivot pole 28 extends through the though hole 260 of the cover 26, the bearing 21, the through hole 25 of the sleeve 24, and the bearing 22 in that order, with a low end of the pivot pole 24 received in the receiving space 120 of the post 12. The pivot pole 28 is mounted to the bearings 21 and 22 by an outer surface of the pivot pole 28 engaging with inner surfaces of the bearings 21 and 22. Thus, the pivot pole 28 can rotate with the bearings 21 and 22.

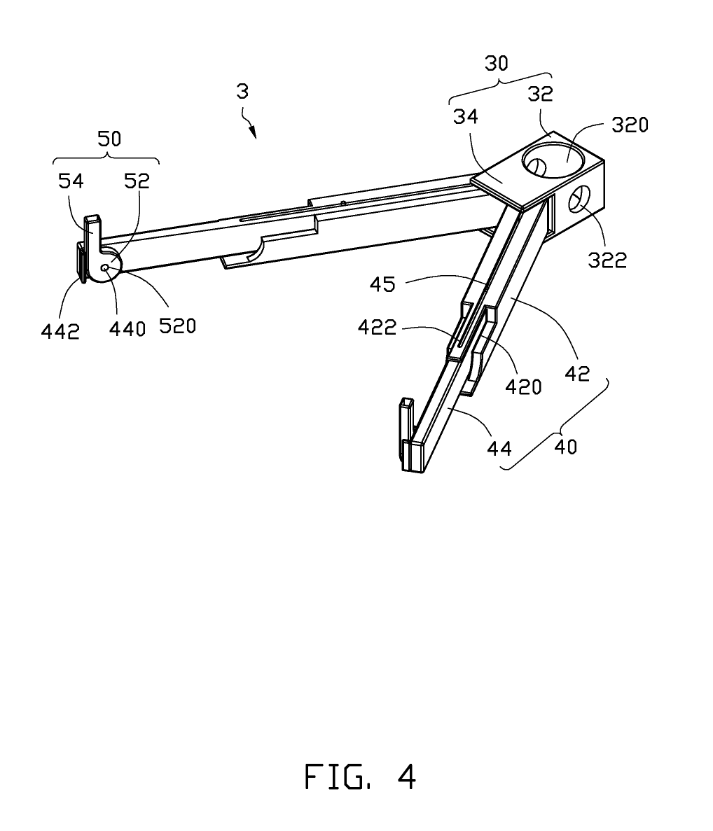

Referring to FIG. 4, each support 3 includes a connection member 30, two legs 40 pivotably mounted to the connection member 30, and two blocks 50 pivotably mounted to the legs 40 opposite to the connection member 30.

The connection member 30 is substantially U-shaped and includes a rectangular main body 32, and two plates 34 substantially horizontally extending from a top and a bottom of a side of the main body 32. The main body 32 defines a first through hole 320 perpendicular to the plates 34, and a second through hole 322 communicating with the first through hole 320 and parallel to the plates 34. A top end of the pivot pole 28 extends through the first through hole 320 of the connection member 30, with the second through hole 322 of the connection member 30 selectively aligning with one of the mounting holes 280 of the pivot pole 28. The fastener 4 extends through the second through hole 322 to engage in the mounting hole 280, to fasten the support 3 at a height corresponding to the pivot pole 28.

Each leg 40 includes a bar-shaped rotatable leg 42 and a slidable leg 44 slidably received in the rotatable leg 42. A first end of the rotatable leg 42 is pivotably mounted to the connection member 30 between the plates 34. The rotatable leg 42 longitudinally defines a slide hole 420 therein through a second end of the rotatable leg 42 opposite to the first end, and a slot 422 in a top surface of the rotatable leg 42 communicating with the slide hole 420. A first end of the slidable leg 44 slidably received in the slide hole 420 defines a fastening hole (not shown), such as a screw hole. A fastener 45, such as a screw, extends through the slot 422 to engage in the screw hole of the slidable leg 44 to fasten the slidable leg 44 to the rotatable leg 42. A pin 440 perpendicularly extends from a second end of the slidable leg 44 opposite to the rotatable leg 42, facing the other leg 40. A tab 442 perpendicularly extends from the second end of the slidable leg 44, adjacent to the pin 440 and opposite to the first end of the rotatable leg 42 about the pin 440.

Each block 50 includes a round main body 52, and a stop portion 54 extending from the main body 52 at a tangent. The main body 52 defines a pivot hole 520. The pin 440 of a corresponding slidable leg 44 is pivotably engaged in the pivot hole 520, to pivotably mount the block 50 to the slidable leg 44. The tab 442 can resist against the stop portion 54 to prevent the block 50 from rotating excessively.

Referring to FIG. 1 again, in use, each support 3 can be mounted at a predetermined height on the pivot pole 28 of the base 1 by the connection member 30 being fastened to a corresponding mounting hole 280. An angle between the legs 40 of the support 3 can be adjusted by rotating the rotatable legs 42, and a size of the support 3 can be adjusted by sliding the slidable legs 44 relative to the rotatable legs 42. Therefore, each support 3 can support different sizes of notebook computers. Each block 50 is rotated about the corresponding pin 440, until the stop portion 54 resists against the corresponding tab 442. The notebook computers 100 are respectively supported on one of the plates 34 of the corresponding connection member 30, and the legs 40 of the corresponding the supports 3, with a front side of each notebook computer 100 resisting against the corresponding stop portions 54 of the blocks 50. Thus, most portions of the notebook computers 100 are exposed to the air, which aids in heat dissipation. Users can freely change positions of the notebook computers 100 by rotating the pivot poles 18 and adjusting the heights of the supports 3 on the pivot pole 18.

It is to be understood, however, that even though numerous characteristics and advantages of the embodiments have been set forth in the foregoing description, together with details of the structure and function of the embodiments, the present disclosure is illustrative only, and changes may be made in details, especially in matters of shape, size, and arrangement of parts within the principles of the embodiments to the full extent indicated by the broad general meaning of the terms in which the appended claims are expressed.

1. A stand assembly comprising:
a base comprising a seat and a pivot pole rotatably mounted to the seat; and
a support used to support a notebook computer;
wherein the support is mounted to the pivot pole, with a height of the support on the pivot pole being adjustable.

2. The stand assembly of claim 1, wherein the base further comprises a sleeve mounted to the seat and two bearings received in a first end away from the seat and a second end of the sleeve opposite to the first end, the sleeve axially defines a through hole, the pivot pole extends through the through hole of the sleeve and the bearings, and is rotatable relative to the seat by the bearings.

3. The stand assembly of claim 2, wherein a post protrudes up from a center of the seat, the post axially defines a receiving space in a top of the post, to receive a low end of the pivot pole.

4. The stand assembly of claim 3, wherein each of the first and second ends of the sleeve defines a receiving portion communicating with the through hole of the sleeve, the receiving portion is substantially T-shaped, and comprises a first groove at each of the first and second ends of the sleeve, and a smaller second groove communicating the first groove with the through hole of the sleeve; the bearings are received in the second grooves; a top of the post opposite to the seat is narrowed to form a shoulder to be received in the first groove of the second end of the sleeve.

5. The stand assembly of claim 4, wherein the base further comprises a cover received in the first groove of the first end.

6. The stand assembly of claim 5, wherein the cover defines a through hole through which the pivot pole extends.

7. The stand assembly of claim 1, wherein the pivot pole defines a plurality of mounting holes at different heights of the pivot hole, the support comprises a connection member, the connection member defines a first through hole through which the pivot pole extends, and a second through hole for a fastener extending through to engage in one of the plurality of mounting holes, thereby fastening the support to the pivot pole.

8. The stand assembly of claim 7, wherein the support further comprises two legs horizontally extending from and rotatably mounted to the connection member.

9. The stand assembly of claim 8, wherein each leg comprises a rotatable leg rotatably mounted to the connection member and a slidable leg slidably mounted to the rotatable leg.

10. The stand assembly of claim 9, wherein the rotatable leg longitudinally defines a slide hole through an end of the rotatable leg opposite to the connection member to slidably receive the slidable leg.

11. The stand assembly of claim 9, wherein the rotatable leg defines a slot communicating with the slide hole in a top of the rotatable leg, a fastener extends through the slot to engage with the slidale leg to fasten the slidable leg to the rotatable leg.

12. The stand assembly of claim 11, wherein the slidable leg of each leg pivotably mounts a block facing the other leg to block a corresponding side of the notebook computer.

13. The stand assembly of claim 12, wherein a tab extends from the slidable leg opposite to the rotatable leg, to stop the block.
